(19) United States
(12) Patent Application Publication
(10) Pub. No.: US 2002/0107985 A1
(43) Pub. Date: Aug. 8, 2002

(54) Providing data services via wireless mobile devices

(75) Inventors: Chiahwong Jack Hwang, Sunnyvale, CA (US); Peter Shieh, Foster City, CA (US)

Correspondence Address: RITTER VAN PELT & YI, L.L.P., 4906 EL CAMINO REAL, SUITE 205, LOS ALTOS, CA, 94022

(73) Assignee: W-Phone, Inc.

(21) Appl. No.: 09/933,139

(22) Filed: Aug. 21, 2001

Related U.S. Application Data
(60) Provisional application No. 60/228,182, filed on Aug. 25, 2000.

(51) Int. Cl. G06F 15/16

(52) U.S. Cl. 709/246; 709/203

(57) ABSTRACT

A method for providing a data service via a wireless mobile device is disclosed. In one embodiment, content associated with the data service and comprising a data component is received at a first node from a content provider. A presentation format is associated with the content. The data component and the associated presentation format are sent to a second node. The content is associated with the wireless mobile device. At least the data component of the content is delivered from the second node to the wireless mobile device.

A system for providing a data service via a wireless mobile device is disclosed. In one embodiment, the system comprises a first server and a second server connected to the first server. The first server is configured to receive, from a content provider, content associated with the data service, the content comprising a data component; associate a presentation format with the content; and send at least the data component of the content and the associated presentation format to the second server. The second server is configured to receive from the first server at least the data component of the content and the associated presentation format; associate the content with the wireless mobile device; and deliver at least the data component of the content to the wireless mobile device via a wireless communication network.

### CROSS REFERENCE TO RELATED APPLICATIONS

This application claims priority to U.S. Provisional Patent Application No. 60/228,182 entitled Providing Data Services Via Wireless Mobile Devices, filed Aug. 25, 2000, which is incorporated herein by reference for all purposes.

### FIELD OF THE INVENTION

The present invention relates generally to wireless communications. More specifically, a system and method for providing data services via wireless mobile devices is disclosed.

### BACKGROUND OF THE INVENTION

Current techniques for delivering content to a mobile device over a wireless network suffer from problems related to retrieving and delivering data between the client mobile devices and the server providing the content. A client is a computation resource (i.e. software and computer) that sends requests to the servers to retrieve data. A server gets the requests from clients and executes the necessary computation to obtain results (i.e. data) and send them to the clients. This model depicts a virtual pipe between a client and a server.

Theoretically, the mobile devices and the backbone host systems can be either clients or servers, depending on whether they are sending requests or serving data (e.g., a web page) in response to requests. Generally speaking, when a mobile device sends a request to the backbone host to retrieve data, it is called a “pull” or “mobile initiated” mode of operation. When a backbone host sends data to a mobile device automatically without having received a request from the mobile device, it is called a “push” or “network initiated” mode of operation.

Today, most data services are provided, to both mobile and stationary clients, using the “pull” model. The World Wide Web is based on this model: A browser is a client that sends HTTP requests to a backbone web server. The web server processes the requests to obtain data and sends them to the browser for displaying.

FIG. 1 shows a typical prior art configuration for providing data services to wireless mobile devices in a browsing mode. The system 100 comprises a plurality of mobile devices 102 connected via a wireless network 104 with an origin server 106 and a proxy server 108. Origin server 106 may be configured to provide certain data services directly to the plurality of mobile devices 102 by transmitting data via the wireless network 104 using known wireless communication protocols. For example, origin server 106 may be configured to serve web pages in the form of the Wireless Markup Language (WML) stored in origin server 106 to the mobile devices 102 using the Wireless Application Protocol.

Proxy server 108 is configured as a proxy or gateway server to connect the wireless network 104 with the Internet 110. For example, proxy server 108 may be configured to communicate with mobile devices 102 via wireless network 104 using known wireless communication protocols and to communicate with devices connected to Internet 110 using Internet communication protocols. Proxy server 108 connects via the Internet 110 with a web server 112. Web server 112 may be configured to serve web pages in a format capable of being used directly by mobile devices 102. For example, web server 112 may be configured to serve web pages in the form of the Wireless Markup Language (WML), which forms part of the Wireless Application Protocol.

If web server 112 is not configured to serve web pages in a form usable by mobile devices 102, a transcoder 114 may be employed to transform web pages served by web server 112 in the form of Hypertext Markup Language (HTML) form, for example, into a format usable by mobile devices 102, such as the Wireless Markup Language (WML). Proxy server 108, in turn, delivers the content to mobile devices 102 via wireless network 104 using known wireless to communication protocols.

In a typical prior art configuration such as that shown in FIG. 1, the users of the mobile devices 102 employ a browsing software, similar to well-known Internet browsers, to access contents stored on servers such as origin server 106 and/or web server 112. The users of mobile devices access specific content by entering a uniform resource locator (URL), which specifies the location of the desired content.

The browsing mode is very popular in stationary devices such as desktop computers. The desktop computers provide a large display and there is sufficient space to support large input devices, such as a keyboard and a mouse. In such an environment, the user may easily navigate content in a browsing mode, such as by selecting choices from large and complicated menus, selecting hypertext links embedded in content, entering the uniform resource locator (URL) of desired content, and entering text to perform searches for desired content. However, this browsing mode of operation is not well suited to mobile devices due to the small display, limited memory, and small keypad of typical mobile devices. As a result, there is a need to provide a way for users of mobile devices to quickly and easily obtain access to the information and data they desire without requiring mobile users to use a browser or other technique that requires data entry or the navigation of menus by the mobile user in order to request access to the desired data services.

In addition to the limited display, memory, and input capacity of the mobile devices, the typically slow connection speed of a mobile device further limits the utility of existing solutions. When the connection speed is slow, the user needs to wait for quite a long time when he wants to retrieve a data. The elapse time between a user's request (e.g., clicking a button on the mobile device) and the data showing up on the screen of the mobile device may average 15-20 seconds for a typical wireless network. This delay results in an unsatisfying experience for the user, who typically is used to the much faster response times available at a desktop computer, for example. Even if the wireless networks migrate to the next generations (so called 2.5G and 3G networks), which are expected to result in increased bandwidth (i.e., transmission capacity), the expected growth in data services will still saturate the available bandwidth.

Other than the bandwidth problem and capacity problem, the service providers also face problems relating to content presentation. Since there are so many different types of mobile devices—ranging from cellular phones, PDA's (Personal Digital Assistants), and electronic viewers—and each with its own screen form factors, it is not possible to provide content in a single, standardize presentation format. Instead, the burden is on the service providers to provide content in as many formats as may be required to serve the variety of devices that may be used to access the content. Currently, the service providers need to generate the presentation format for each request in their backend system, and which makes the response time even longer.

All the above factors lead to an unsatisfactory user experience with wireless data services.

There is a need, therefore, for an improved data delivery and management method and system for mobile devices. In particular, there is a need for a data delivery method and system in which the user experience is not made less satisfactory due to the limited bandwidth of the wireless networks and the display and input limitations of mobile devices. There is also a need to enable backend service providers to provide content to mobile devices without having to generate presentation format data for many kinds of mobile devices each time new content is created or sent.

### SUMMARY OF THE INVENTION

A system and method for providing data services via wireless mobile devices is disclosed. The creation by a content provider of content to be delivered to one or more wireless mobile devices is described. The processing of the content to associate a presentation format with a data component of the content is disclosed. Further processing of the content, such as to identify the wireless mobile device or devices to which the content is to be delivered and/or to perform computations necessary to deliver the content, is described. The delivery of processed content to one or more wireless mobile devices is disclosed.

It should be appreciated that the present invention can be implemented in numerous ways, including as a process, an apparatus, a system, a device, a method, or a computer readable medium such as a computer readable storage medium or a computer network wherein program instructions are sent over optical or electronic communication links. Several inventive embodiments of the present invention are described below.

A method for providing a data service via a wireless mobile device is disclosed. In one embodiment, content associated with the data service and comprising a data component is received at a first node from a content provider. A presentation format is associated with the content. The data component and the associated presentation format are sent to a second node. The content is associated with the wireless mobile device. At least the data component of the content is delivered from the second node to the wireless mobile device.

A system for providing a data service via a wireless mobile device is disclosed. In one embodiment, the system comprises a first server and a second server connected to the first server. The first server is configured to receive, from a content provider, content associated with the data service, the content comprising a data component; associate a presentation format with the content; and send at least the data component of the content and the associated presentation format to the second server. The second server is configured to receive from the first server at least the data component of the content and the associated presentation format; associate the content with the wireless mobile device; and deliver at least the data component of the content to the wireless mobile device via a wireless communication network.

These and other features and advantages of the present invention will be presented in more detail in the following detailed description and the accompanying figures, which illustrate by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1 shows a typical prior art configuration for providing data services to wireless mobile devices in a browsing mode.

FIG. 2 is a schematic diagram representing a system 200 used in one embodiment to provide data services via wireless mobile devices.

FIG. 3 is a flowchart illustrating a process used in one embodiment to provide data services via wireless mobile devices using a system such as the system 200 of FIG. 2.

FIG. 4A shows the data structure of an illustrative service data record 400 associated with a particular content provider, such as may be stored in service data database 210 shown in FIG. 2.

FIG. 4B shows the data structure of an illustrative service data sub-record, such as the first and second service data sub-records 412 and 414 of FIG. 4A.

FIG. 4C shows the data structure for an illustrative content data sub-record 440, such as the first and second content data records 430 and 432 of FIG. 4B.

FIG. 5A shows an illustrative user profile record 500 used in one embodiment to store user profile data, such as in user profile database 212 of FIG. 2.

FIG. 5B shows a data structure used in one embodiment for a subscription data sub-record 540, such as the first subscription data sub-record 522 and second subscription sub-record 524 of FIG. 5A.

FIG. 6 is a schematic diagram showing a portion of a system used in one embodiment to provide data services via wireless mobile devices.

FIG. 7 is a flowchart illustrating a process used in one embodiment by a metadata engine, such as metadata engine 609 of FIG. 6 to manage the transfer of data from a service data database and a user profile database, such as service profile database 610 and user profile database 612 of FIG. 6, to a local server, such as local server 614 of FIG. 6.

FIG. 8 is a flowchart illustrating a process used in one embodiment to process content at a regional server.

FIG. 9 is a schematic diagram illustrating a portion of a system used in one embodiment to deliver data services via wireless mobile devices.

FIG. 10 is a flow chart illustrating a process used in one embodiment to process content at a local server and deliver content to one or more users of wireless mobile devices in a push mode.

FIG. 11 is a flow chart of a process used in one embodiment by a local server rule engine to process content, as in step 1006 of FIG. 10.

FIG. 12 is a flow chart illustrating a process used in one embodiment to deliver content from a local server to one or more wireless mobile devices via a wireless network in a pull mode.

FIG. 13 is a flow chart illustrating a process used in one embodiment to process content at a local server and deliver such content to one or more wireless mobile devices via a wireless network in a pull mode of operation.

### DETAILED DESCRIPTION

A detailed description of a preferred embodiment of the invention is provided below. While the invention is described in conjunction with that preferred embodiment, it should be understood that the invention is not limited to any one embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

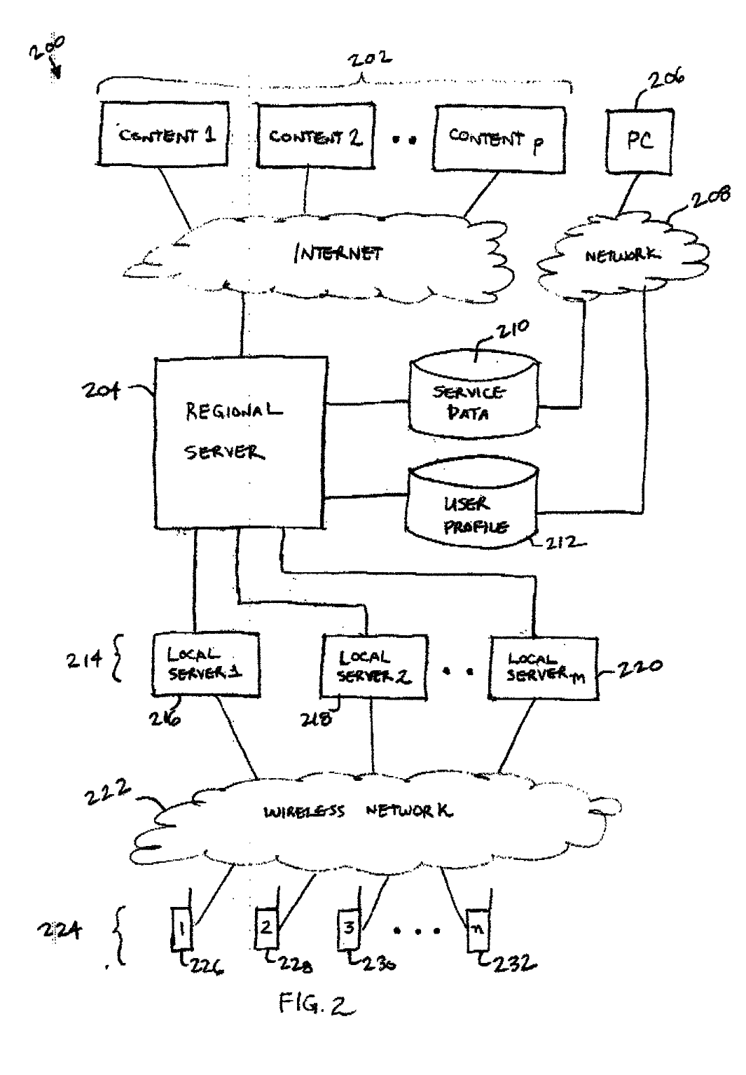

FIG. 2 is a schematic diagram representing a system 200 used in one embodiment to provide data services via wireless mobile devices. The system 200 comprises a plurality of content providers 202 connected via the Internet to a regional server 204. In FIG. 2, only one regional server is shown. However, regional server 204 may be one of a plurality of regional servers, each regional server serving, for example, a different geographical region. In one embodiment, a plurality of regional servers is employed. In one embodiment, load sharing algorithms known in the art are employed to distribute the load among a plurality of regional servers on the basis of demand. In addition, while in FIG. 2 the content providers 202 are connected to the regional server 204, the content providers may also or instead be connected to the regional servers by means of a virtual private network (VPN) or other private network, or by modem or other connection.

The system 200 also comprises a personal computer 206 connected via a network 208 to a service data database 210 and a user profile database 212. In one embodiment, the network 208 is the Internet. In one embodiment, the network 208 is a virtual private network or other private network. While a single personal computer 206 is shown in FIG. 2, a plurality of personal computers may be connected via network 208 to the service data database 210 and the user profile database 212. For example, one personal computer such as represented by personal computer 206 may be a personal computer employed by one of the plurality of content providers 202 to connect with the service data database 210 via network 208. A different personal computer such as represented by personal computer 206 may be used by a mobile device user, for example, as explained more fully below, to access the user profile database 212 via network 208. The connection between personal computer 206 and the service data database 210 and/or the user profile database 212 may be implemented in other ways, such as a web server. In one alternative embodiment, computing and/or communication devices other than a personal computer may be used to access the service data database 210 and/or the user profile database 212.

FIG. 2 further shows the regional server 204 connected to a plurality of local servers 214, represented in FIG. 2 by local servers 216, 218, and 220. The connection between the regional server 204 and each of the plurality of local servers 214 is shown in FIG. 2 as a direct logical connection. However, the actual connection between regional server 204 and the local servers 214 may be implemented in any number of ways, including as a network connection, such as a local area network (LAN) connection, or by a connection through a public or private network, such as via the Internet or a virtual private network or other private network, or as a direct physical connection, all of which techniques are well known in the art. In addition, while the system 200 as shown in FIG. 2 includes a plurality of local servers, a single local server may also be connected to regional server 204, depending on the requirements of a particular area or application, such as the number of mobile users to be served or the demand for mobile data services.

As shown in FIG. 2, each of the plurality of local servers 214, represented in FIG. 2 by local servers 216, 218, and 220, is connected via wireless network 222 with a plurality of mobile devices 224, represented in FIG. 2 by mobile devices 226, 228, 230, and 232.

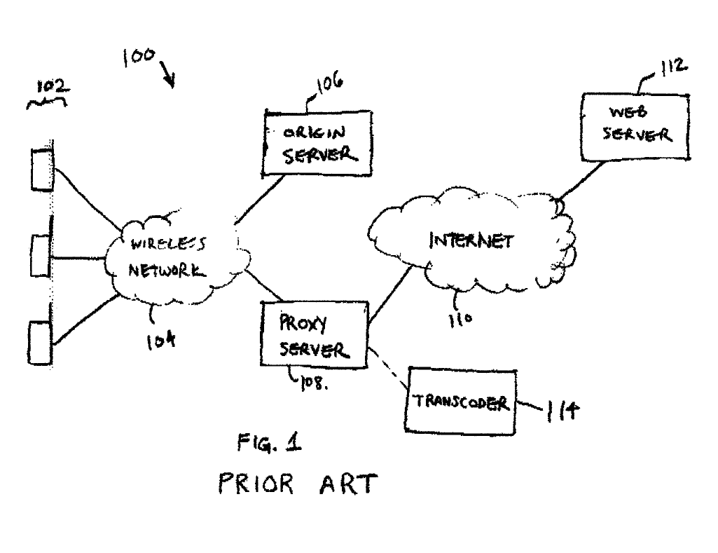

The system 200 shown in FIG. 2 may coexist with additional systems and services, such as a browser-based service of the type shown in FIG. 1 and described above. For example, the mobile devices 224 shown in FIG. 2 may in addition be connected via wireless network 222 to additional servers such as an origin server 106 of FIG. 1 or a proxy server such as proxy server 108 of FIG. 1 to provide browser-based services.

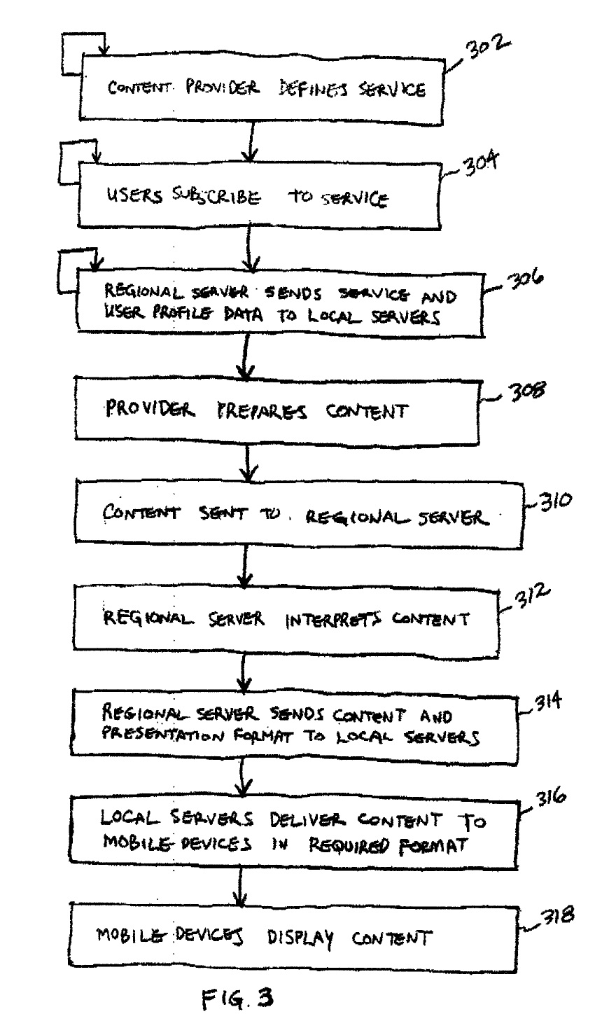

FIG. 3 is a flowchart illustrating a process used in one embodiment to provide data services via wireless mobile devices using a system such as the system 200 of FIG. 2. In step 302, a content provider defines a new service. In one embodiment, a new service is defined by using a personal computer such as personal computer 206 of FIG. 2 to access a service data database such as service data database 210 of FIG. 2 to create a record or set of records that define the new service. In one embodiment, the definition of the service includes such information as the identity of the content provider providing the service, the name of the service, a list of the users subscribed to the service, and information necessary to process the content to be received from the content provider in connection with the service, as described more fully below.

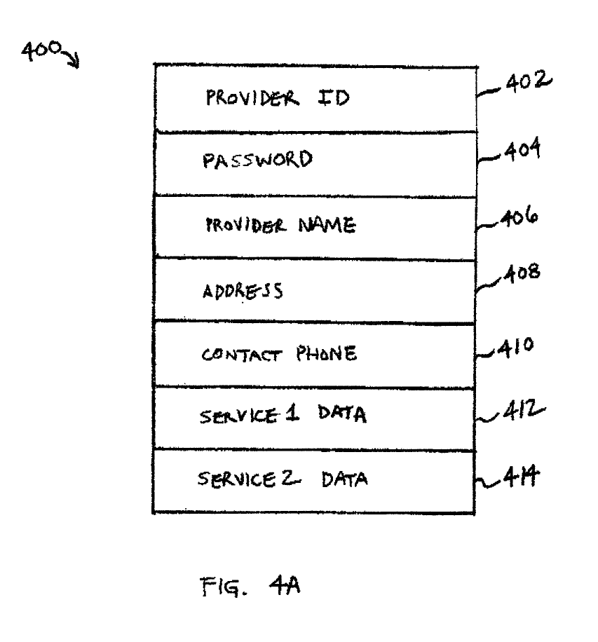

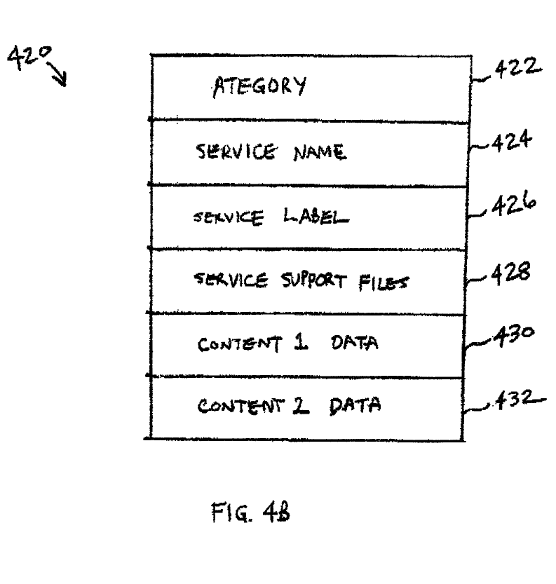

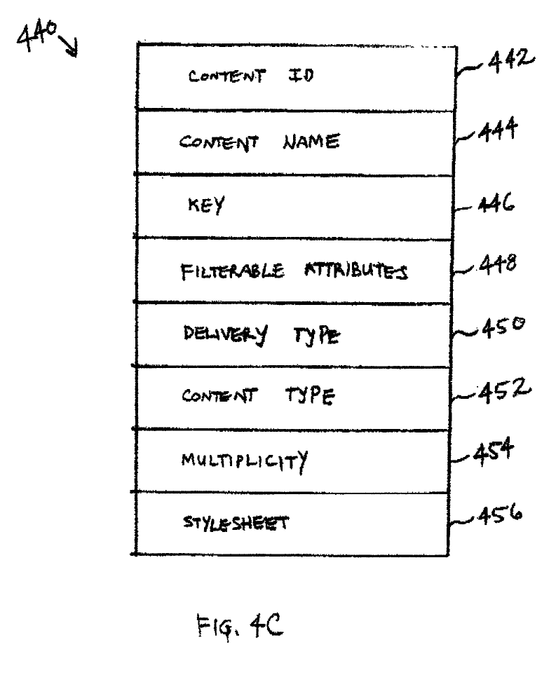

FIG. 4A shows the data structure of an illustrative service data record 400 associated with a particular content provider, such as may be stored in service data database 210 shown in FIG. 2. The service data record 400 includes a provider ID field 402 in which a unique identifier for the content provider is stored. The service data record 400 also includes a password 0 field 404 in which a password associated with the content provider is stored. In one embodiment, the password is used to provide password-protected access to the service data database.

The service data record 400 further includes a name field 406 in which the content provider's name is stored. The service data record 400 also includes an address field 408 in which the content provider's address is stored. The service data record 400 also includes a contact phone field 410 in which the contact phone number for the content provider is stored.

The service data 400 also includes a first service data sub-record 412 in which data associated with a first service provided by the content provider is stored, and a second service data sub-record 414 in which data associated with a second service provided by the content provider is stored. While the service data record 400 is shown in FIG. 4A as including sub-records for service data for a first service and a second service, a particular content provider may provide only one service or may provide more than two services, in which case the number of service data sub-records included in the service data record for that particular content provider would correspond to the number of different services provided by the content provider.

FIG. 4B shows the data structure of an illustrative service data sub-record, such as the first and second service data sub-records 412 and 414 of FIG. 4A. A service data sub-record 420 includes a category field 422 in which an identification of the category of service in which the service is classified is stored. The sub-record 420 further includes a field 424 in which the service name is stored. The sub-record 420 also includes a service label field 426 in which an identifier for the service is stored.

The sub-record 420 includes a service support file area 428 in which support files associated with the service are stored. In one embodiment, the service support files may include a type definition file used to define the syntax to be used for tags or rules associated with content associated with the service.

The service data sub-record 420 further includes a first content data sub-record 430 and a second content data sub-record 432. The first content data sub-record 430 is used to store data associated with a first content type associated with the service and the second content data sub-record 432 is used to store data associated with a second content type associated with the service. While two content data sub-records are shown in the illustrative service data sub-record 420 shown in FIG. 4B, a particular service may have just one type of content or more than two types of content associated with it, in which case the service data sub-record 420 would include as many content data sub-records as necessary to store data associated with each different type of content that may be provided as part of the service.

FIG. 4C shows the data structure for an illustrative content data sub-record 440, such as the first and second content data records 430 and 432 of FIG. 4B. The content data sub-record 440 includes a content ID field 442 in which a unique identifier associated with the content type is stored. The content data sub-record 440 also includes a content name field 444 in which the name by which the content is identified is stored.

The content data sub-record 440 further includes a key field 446 in which one or more keywords and/or other keys are stored, which identify the specific content associated with the content data sub-record 440. For example, for a weather information service, the key field 446 may be used to store a city name, such as San Francisco, to identify the associated content as weather information about San Francisco.

The content data sub-record 440 also includes a filterable attributes field 448 in which one or more filterable attributes may be defined. A filterable attribute is an attribute that may be used to identify one or more users as a proper recipient to whom the content should be delivered. For example, the user's age may be defined as a filterable attribute, enabling a content provider to indicate in content provided in connection with the service that a particular piece of content should be delivered only to users age 30 and above.

The content data sub-record 440 also includes a delivery type field 450 in which the manner of delivery of the content is stored. The delivery type field may be used, for example, to indicate that the associated content should be delivered in a pull mode, a WAP push mode, an SMS push mode, or some other mode of delivery of content via a wireless network.

The content data sub-record 440 also includes a content type field 452 in which an indication of the nature of the content associated with the content data sub-record is stored. The content type may be text, graphics, audio, video, or any other type of content deliverable over a wireless network.

The content data sub-record 440 also includes a multiplicity field 454, in which an indication is stored of how many instances of the content having the same content ID can be cached in the system. For example, it may be possible to cache the three most recently received instances of content associated with a particular content ID.

The content data sub-record 440 includes a stylesheet field 456 in which one or more style sheets, each defining the presentation format for the content associated with the content data record 440, are stored. In one embodiment, the style sheet comprises code written in extensible stylesheet language (XSL) for converting or partially converting XML documents into other forms, such as HTML or WML. In one embodiment, the stylesheet is stored separately and an indicator associated with the stylesheet is stored in stylesheet field 456.

The record 400 may comprise other, different, or additional fields as necessary to define adequately the parameters of a service.

Referring further to FIG. 3, step 302 may be repeated as necessary, by the same content provider or by different content providers, to define additional new services. In addition, the step 302 may be repeated as necessary to update the service definition for an existing service.

In a step 304 of the process shown in FIG. 3, one or more users subscribe to the service defined in step 302. In one embodiment, a user subscribes to a service by using a personal computer such as the personal computer 206 of FIG. 2 to access a user profile database such as user profile database 212 of FIG. 2 to modify the user's profile to include the additional service. In one embodiment, the user communicates directly with the content provider to subscribe to the service and the content provider updates the service data database to reflect that the user has subscribed. In one embodiment, the content provider accesses the newly-subscribed user's profile in the user profile database to define additional records and/or fields as may be necessary to enable the newly-subscribed user to define the user's preferences with respect to the service.

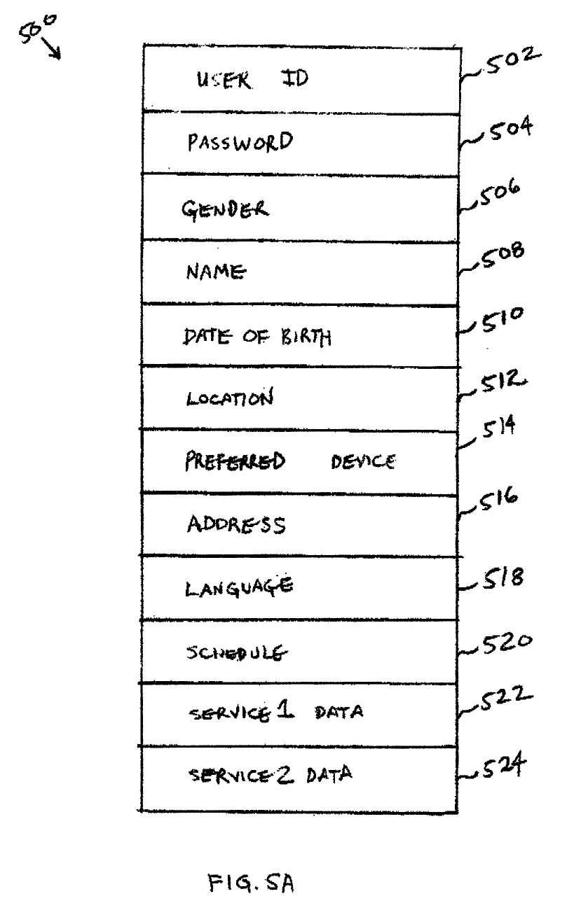

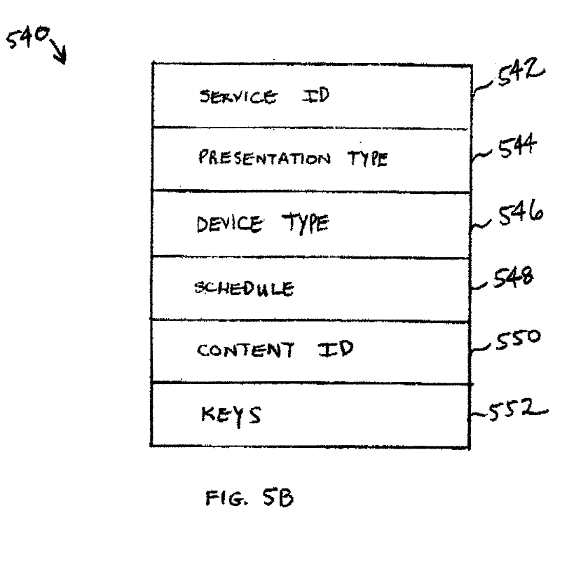

FIG. 5A shows an illustrative user profile record 500 used in one embodiment to store user profile data, such as in user profile database 212 of FIG. 2. The user profile data record 500 includes a user ID field 502 in which an identifier associated with the user is stored. The user data profile record 500 further includes a password field 504 in which the user's password is stored.

The user profile data record 500 further includes a gender field 506, a name field 508, and a date of birth field 510 in which the indicated personal data of the user is stored. While the user profile data record shown in FIG. 5A includes fields for the gender, name, and date of birth of the user, other or additional fields may be provided depending on the information it may be necessary or advantageous to store in a particular application.

The user profile data record 500 further includes a location field 512 in which the primary location of the user is stored. In one embodiment, the location field 512 is used to store data indicating which local server should be used to provide service to the user associated with the user profile data record 500.

The data record 500 further includes a preferred device field 514 used to store an indication of the primary wireless mobile device used by the user to receive content.

The data record 500 also includes an address field 516 used to store information necessary to deliver content to the mobile wireless device associated with the user. In one embodiment, the address field 516 is used to store the mobile station integrated international service digital network (MSISDN) number associated with the user's mobile device. The MSISDN includes a network identifier and a number such as a telephone number, identifying the particular mobile device within the network associated with the network identifier.

The data record 500 also includes a language field 518 in which the language in which content should be delivered to the user is stored. The data record 500 also includes a schedule field 520 in which the user may store data indicating the schedule for delivery of content to the user. In one embodiment, the schedule field 520 is used to provide a schedule for the delivery of only that content for which a content-specific schedule is not separately established, as explained more fully below.

The user profile data record 500 further comprises a first subscription data sub-record 522 and a second subscription data sub-record 524 used to store data associated with a first subscription and a second subscription, respectively. While two subscription data sub-record fields are shown in the illustrative user profile data record 500 shown in FIG. 5A, a particular user may choose to receive data under only one service or under three or more services, in which case the user profile data record associated with that user would include as many subscription data sub-records as necessary to store data associated with all of the services to which the user has subscribed. In this context, and throughout this application, the term subscribed is used broadly to indicate any service with respect to which the user has arranged to receive content without regard for whether there is a separate account or charge for each individual or any particular individual service.

FIG. 5B shows a data structure used in one embodiment for a subscription data sub-record 540, such as the first subscription data sub-record 522 and second subscription sub-record 524 of FIG. 5A. The subscription data sub-record 540 includes a service ID field 542 used to store a unique identifier for the service to which the user has subscribed.

The subscription data sub-record 540 includes a presentation type field 544 in which an indication of the presentation format to be used to provide the content associated with the service is provided. For example, if content may be provided in two different presentation formats for a particular service, the presentation type field 544 may be used to store an indication of which of the two available presentation formats should be used to deliver the content to the user associated with the subscription data sub-record 540.

The subscription data sub-record 540 further includes a device type field 546 in which an indication of the device type associated with the user is stored. In one embodiment, the device type data is used to ensure that the presentation format used to deliver the content to the user is compatible with the user's device. In one embodiment, the user may use one type of device to receive content associated with a first service, and a second type of device to receive content associated with a second service.

The subscription data sub-record 540 further includes a schedule field 548 in which the user may store an indication of the schedule under which the user desires to receive content associated with the service. In one embodiment, a content or service-specific schedule stored in a field such as schedule field 548 would override, for the particular content with which it is associated, the schedule information stored in a more general schedule field such as schedule field 520 shown in FIG. 5A.

The subscription data sub-record 540 further includes a content ID field 550, which identifies the content within the service that is to be delivered to the user. In one embodiment, the content delivered to the particular user is determined by matching the content ID of content received from the content provider who provides the service with the content ID stored in a user subscription data sub-record content ID field such as content ID field 550.

The subscription data sub-record 540 includes a keys field 552 in which one or more keywords and/or other keys may be stored to indicate which particular content associated with the service is of interest to the user. For example, a user may store a keyword “San Francisco” in the keys field 552 for a subscription data sub-record associated with a weather information service to indicate the user wishes to receive weather information for San Francisco. In one embodiment, content received from a content provider of such a weather information service would be delivered to such a user only if the content included a key corresponding to San Francisco, indicating the particular content included weather information regarding San Francisco.

Referring further to FIG. 3, the step 304 may be repeated, as necessary, to permit the same user and/or other users to subscribe to as many services as each may desire. In one embodiment, in step 304 a user may also access the user's profile associated with an existing service to change the user's preferences with respect to the service.

In step 306 of the process shown in FIG. 3, the regional server sends service data and user profile data to the local servers. For example, in the system 200 shown in FIG. 2, the regional server 204 may access service data from the service data database 210 and user profile data from the user profile database 212 and to send the service data and user profile data to each of the plurality of local servers 214. In one embodiment, the regional server forwards all service data and all user profile data to each local server of the plurality of local servers 214. In one alternative embodiment, the regional server forwards to each local server of the plurality of local servers 214 only that service data and user profile data applicable to the individual local server. For example, in one embodiment, the regional server sends to each local server only the user profile data associated with the users served by that local server and only the service data associated with services subscribed to by users associated with that local server.

Step 306 is repeated as desired for a particular application. For example, in one embodiment step 306 is repeated at a designated frequency. In one embodiment, step 306 is repeated each time new user profile and/or service data has been received.

Further, while steps 302, 304, and 306 are shown in FIG. 3 as discrete, successive steps, for purposes of illustration and clarity, these steps and certain other steps of the process shown in FIG. 3 may occur simultaneously and/or in other or different order, depending for example on the timing of the receipt of updates to user profile and/or service data and/or other events.

In step 308 of the process shown in FIG. 3, a content provider provides new content to be provided in connection with a previously-defined service. In one embodiment, the content is prepared in the form of XML code that includes an identification of the content provider, an indication of the presentation format to be used to display the content, and the data to be displayed. In one embodiment, the presentation format is indicated by means of a code associated with a previously-defined presentation format, such as may be stored in or associated with data stored in the stylesheet field 456 of the data sub-record 440 of FIG. 4C. In one embodiment, the specific code that defines the presentation format, such as XSL code, may be embedded in the content. In one embodiment, no indication of the presentation format is included in the content received in step 308. In one such embodiment, the presentation format is associated with the content based on data stored in the service data database, such as data stored in the stylesheet field 456 of the data sub-record 440 of FIG. 4C.

In one embodiment, the code used to define the content includes code that defines rules governing how the content should be processed. For example, in one embodiment, the code defining the content may include rules defining a subset of users of the service that should receive the content. For example, the content provider for a hypothetical service birthday.gift, described more fully below, may wish to include a rule indicating that the content should be provided only to users of the service who have a spouse who is at least 30 years old.

In step 310 of the process shown in FIG. 3, the content prepared by the content provider is sent to a regional server. For example, in the system shown in FIG. 2, one of the plurality of content providers 202 may send content via the Internet to the regional server 204 in the form of XML code. In one embodiment, the content provider prepares content in the form of XML and pushes the content to the regional server (i.e., sends the content to the regional server without having first received a request from the regional server to provide the content). In one embodiment, the regional server operates in a pull mode, requesting content from one or more content providers. In one embodiment, content requested by the regional server may be in a form other than XML, such as HTML or WML. In one such embodiment, the regional server is configured to parse HTML and/or WML content to transform it to XML.

In step 312 of the process shown in FIG. 3, the regional server interprets the content received from the content provider. In one embodiment, in step 312, the regional server interprets the content by extracting presentation format information from the content received from the content provider. In one embodiment, the regional server interprets the content by identifying and accessing or assembling the presentation format code associated with the presentation format indicated by the content received from the content provider, such as XSL code, and associates the presentation format code with the data portion of the content received from the content provider. In one embodiment, the content received by the regional server from the content provider includes a format identifier, which the regional server associates with the correct presentation format. In one embodiment, the content received by the regional server does not include presentation format information and the regional server associates one or more presentation formats with the content. In one such embodiment, the regional server uses data stored in the server data database to associate one or more presentation formats with the content.

In one embodiment, the presentation format code, such as XSL code, may itself be embedded as data in the content received by the regional server from the content provider. In such an embodiment, the presentation format code may be extracted from the content and associated by the regional server with the data portion of the content.

In one alternative embodiment, the regional server does not interpret the content received from the content provider and instead merely forwards the content to the local servers in the form in which it is received from the content provider. In such an embodiment, in step 312 of the process shown in FIG. 3 is omitted.

In step 314 of the process shown in FIG. 3, the regional server sends the data portion of the content and the presentation format information to the local servers. In one embodiment, the data portion of the content is sent in the form of the data portion of the XML code received by the regional server from the content provider. In one embodiment, the presentation format information is sent by the regional server to the local servers in the form of presentation format code, such as XSL code, associated with the data portion of the content received by the regional server from the content provider.

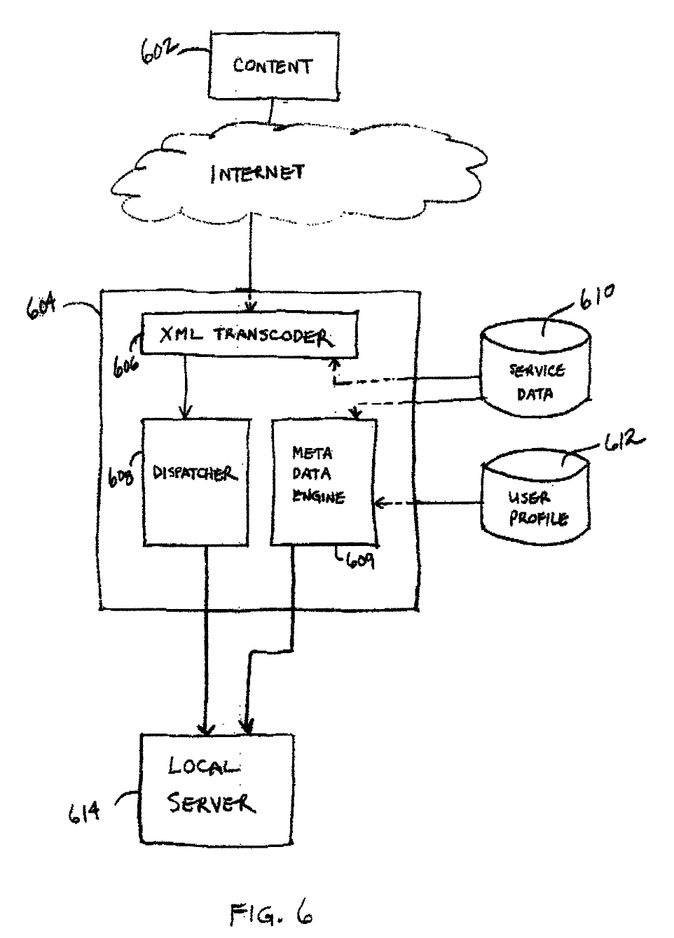

The operation of the regional server in step 312 and 314 of the process shown in FIG. 3 is described further below in connection with the discussion of FIGS. 6, 7, and 8.

In step 316 of the process shown in FIG. 3, the local servers deliver content to one or more mobile devices in the respective format required for each destination device. In one embodiment, as described above, the content provided by the content provider may include rules governing which users should receive the content. In one such embodiment, the local servers interpret and apply such rules, using as necessary data from the service data database and/or the user profile database.

For example, a user profile may include a data field such as the following:

<spouse.birthdate>mm/dd/yyyy</spouse.birthdate>

in which the date of birth of the user's spouse is stored.

Continuing with the example, a content provider may provide a birthday gift service named “birthday.gift,” for offering products and/or services for purchase as birthday gifts.

The content provider may, for example, send content in connection with the birthday.gift service, which contains the following rule:

<rule>today.date—spouse.birthdate>30</rule>

The content provider may wish to include the above rule, for example, because a gift item they are promoting is thought to be appealing to or suitable for persons age 30 and above and thought to be suitable to be given as a gift to a spouse, due to the intimate nature of the gift item, for example.

Suppose further that the user profile includes the following:

<service1>
<service.name> birthday.gift <service.name>
</service1>

which identifies the user as a user desiring and/or entitled to receive content associated with the birthday.gift service. The user profile further includes the following preference established by the user with respect to the birthday.gift service:

```
<service 1>
    <preference> service.name=birthday.gift && (today.date -
    spouse.birthdate) <=20 </preference>
</service 1>.
```

A user may establish such a rule, for example, because the user only wants to receive birthday gift suggestions from the birthday.gift service within 20 days of the user's spouse's birthday.

Finally, the service data database contains a set of records associated with the birthday.gift service, including a list of subscribed users, as well as a document type file, which defines how the tag “rule” should be interpreted for content associated with the birthday.gift service.

In one embodiment, the above content, service data, and user profile data would be processed at the local server as follows: First, the local server would recognize the content as being associated with the birthday.gift service and would access the service data for that service. The local user would then narrow the processing to the users listed in the subscriber list included in the service data. Other service data may be used to process the content in other ways. The local server would then process the rule contained in the data. The local server would recognize that the rule requires the processing of user profile data. The local server would therefore retrieve the required user profile data associated with the users on the subscriber list, which data would be used to limit the list of potential recipients further to those users on the subscriber list having a spouse who is over 30 years old. For the users on the latter further limited list, the local server would further process user profile data associated with the service, such as the user preference described above. In the example described above, the content would only be delivered to the user if the user's spouse were over 30 years old and the spouse's birthday were going to occur within 20 days.

In one embodiment, the local servers operate in a push mode, delivering content to associated mobile devices without receiving from the mobile device a request to deliver content. Examples of such push technology include WAP-push and SMS-push. In one embodiment, the local servers, wireless network, and mobile devices are configured to support so called “always on” operation, in which content may be delivered by a local server to a mobile device via the wireless network at any time, regardless if the user has activated the mobile device at that time and even if the user is using the mobile device for another task, such as to make a voice telephone call. Current and contemplated examples of such technology include General Packet Radio Service (GPRS) systems and other 2.5G and 3G generation wireless technologies. In one such embodiment, in step 316 of the process shown in FIG. 3, local servers deliver content to mobile devices as soon as the local server has finished processing the content and performing any computations that may be required to tailor the content to specific mobile users. In one embodiment, the local server does not process the content and instead forwards the unprocessed content to the mobile devices, which then process the content at the mobile device level, such as by performing computations necessary to personalize the content for the user of the mobile device.

In one embodiment, the local servers are configured to operate in a pull mode in which content is delivered to a mobile device in response to a signal received at the local server by which the mobile device registers with the local server. In one embodiment, a mobile device sends such a signal to the local server upon activation of the mobile device by the user. In one embodiment, such a signal is sent from the mobile device to the local server in response to a command received by the mobile device from the user. Such a command may take any of a variety of well-known forms of input, such as a voice command or a keypad selection.

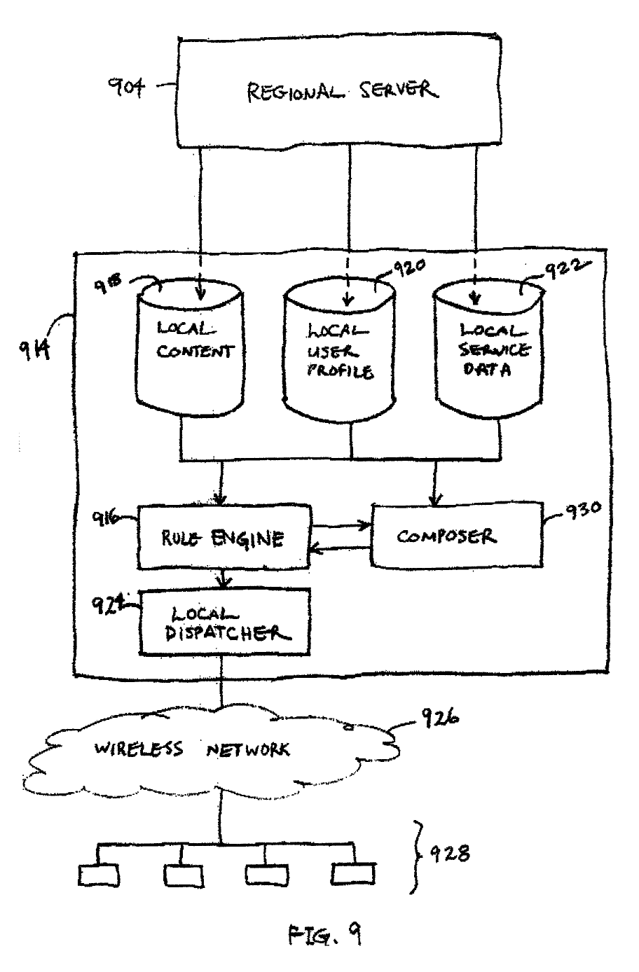

The operation of the local servers as in step 316 of the process shown in FIG. 3 is described more fully below in connection with FIGS. 9-13.

In step 318 of the process shown in FIG. 3, the mobile devices display the content received from the local servers.

FIG. 6 is a schematic diagram showing a portion of a system used in one embodiment to provide data services via wireless mobile devices. The portion of the system shown in FIG. 6 includes a regional server 604 connected via the Internet to an exemplary content provider 602. In one embodiment, the regional server 604 is connected to the content provider 602 through a network other than the Internet, such as a virtual private network or other private network.

The regional server 604 comprises an XML transcoder 606 configured to receive and transcode content received by regional server 604 from content provider 602. As described more fully below, the XML transcoder uses data from the service data database 610 to interpret the content received from the content provider. In one embodiment, the XML transcoder interprets the content at least in part by associating a presentation format with the data contained in the content.

The regional server 604 further comprises a dispatcher 608 configured to receive interpreted content from the XML transcoder 606 and deliver such content to one or more local servers such as local server 614 of FIG. 6. In one embodiment, the dispatcher forwards the data portion of content to the local server in XML format and the presentation format portion of the content to the local server in a format other than XML, such as XSL, HTML, or WML.

The regional server 604 further comprises a metadata engine 609 configured to retrieve data from the service data database 610 and from user profile database 612 and to send the retrieved service data and user profile data to one or more local servers, such as local server 614 of FIG. 6. In one embodiment, the metadata engine sends the database information to the local server in XML format.

While separate logical connections are shown between service data database 610 and XML transcoder 606 on the one hand and metadata engine 609 on the other, such connections between service data database 610 and regional server 604 may be implemented in any number of ways, including, for example, as a single physical or network connection. Likewise, while separate logical connections are shown in FIG. 6 between the local server 614 and the dispatcher 608 on the one hand and the metadata engine 609 on the other, such logical connections may be implemented in any number of ways, including for example by means of a single physical or network connection.

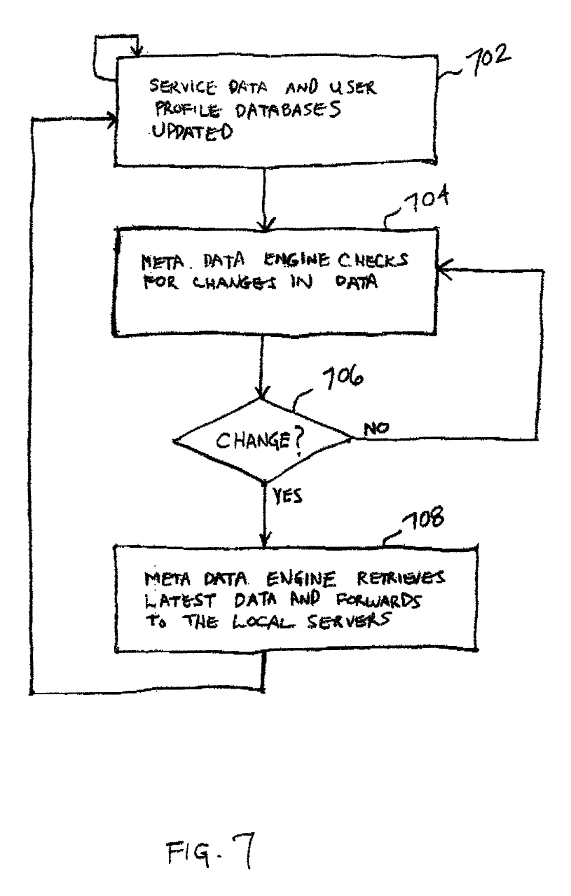

FIG. 7 is a flowchart illustrating a process used in one embodiment by a metadata engine, such as metadata engine 609 of FIG. 6 to manage the transfer of data from a service data database and a user profile database, such as service profile database 610 and user profile database 612 of FIG. 6, to a local server, such as local server 614 of FIG. 6. In step 702 of the process shown in FIG. 7, the service data database and user profile database are updated. Step 702 may be repeated as necessary to permit content providers and/or users to update information on either database, as appropriate. For example, in one embodiment, the content provider is permitted to access and change the service data database for purposes of defining a new service or making changes to the record or records associated with an existing service. In one embodiment, the content provider is permitted to access the user profile database to define additional records and/or fields within the user profile of users associated with a service, such as subscribers to the service. In one embodiment, users are permitted to access the user profile database to update their own user profile, such as by indicating preferences for services to be delivered to the user.

In step 704 of the process shown in FIG. 7, the metadata engine checks for changes in the data stored in either the service data database or the user profile database. In one embodiment, the metadata engine checks for changes in data in the service data and user profile databases periodically, such as every ten minutes. In one embodiment, the metadata engine checks for changes in the service data and user profile data whenever new content is received at the regional server. In one embodiment, the metadata engine checks for changes in the service data and user profile data upon receipt of a query from a local server.

In step 706 of the process shown in FIG. 7, it is determined by the metadata engine whether any change has occurred in either the service data or the user profile data since the last time the metadata engine forwarded service data and user profile data to the local servers. If it is determined in step 708 that no change has occurred, the process returns to step 704 in which the metadata engine checks for changes in the data at the next appropriate time, such as at the expiration of a prescribed interval or upon receipt of new content at the regional server. If it is determined in step 706 that either the service data or user profile data has changed, the process proceeds to step 708 in which the metadata engine retrieves the latest data from the appropriate database and forwards the data to the local servers. Once the metadata engine has forwarded the updated data to the local servers in step 708, the process returns to the beginning and further updates to the service data and user profile data may be made, detected, and processed as described above.

In one alternative embodiment, the metadata engine does not check for changes in the service data database or the user profile database and instead simply forwards all information in those databases to the local server at a prescribed interval or in accordance with a pre-established schedule. In one embodiment, the metadata engine does not check for changes in the service data database or the user profile database and instead receives an alert when a change has been made to the service data or the user profile data. In one such embodiment, the metadata engine forwards updated database information to the local servers in response to receiving such an alert.

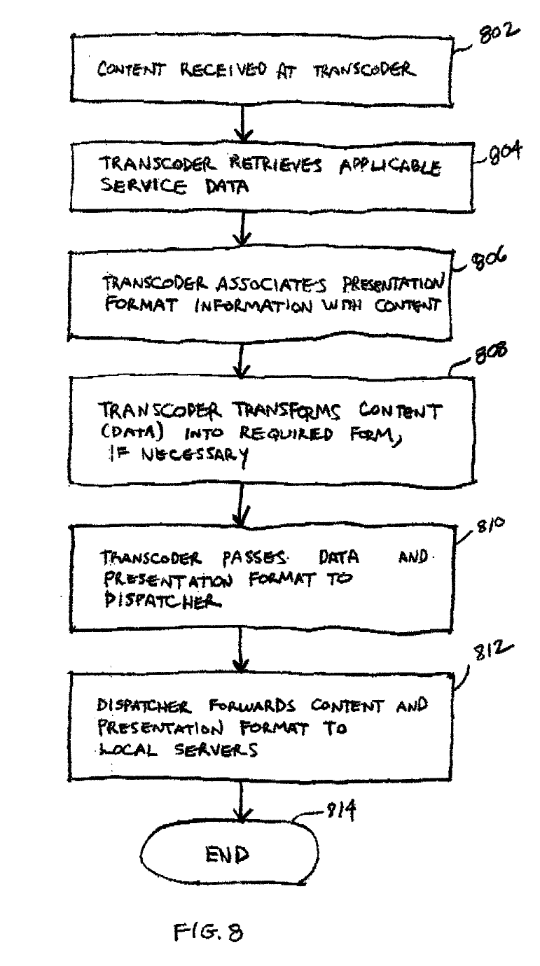

FIG. 8 is a flowchart illustrating a process used in one embodiment to process content at a regional server. In step 802 content is received at a transcoder, such as the XML transcoder 606 of FIG. 6. In one embodiment, the content is received in the form of XML.

In step 804, the transcoder retrieves applicable service data. In one embodiment, the service data is retrieved from a service data database such as database 610 of FIG. 6. As described above in connection with FIGS. 4A-4C, the applicable service data may include such information as the type definition file associated with the applicable service, presentation format information, and data retention information.

In step 806, the transcoder retrieves from the service data database presentation format information corresponding to one or more presentation formats associated with the content. In one embodiment, the presentation format information is a presentation format identifier, such as a symbol, which the transcoder is configured to associate with one or more stylesheets such as those described above in connection with stylesheet field 456 of FIG. 4C.

In step 808 of the process shown in FIG. 8, the transcoder transforms the data portion of the content received from the content provider into the form in which it will be transmitted to the local servers. In one embodiment, the data portion of the content is received by the regional server from the content provider in the form XML and in step 808 the transcoder transforms the data portion into the appropriate presentation format. In one embodiment, the content is received by the regional server from the content provider in the form in which it is to be presented and step 808 is omitted. In one embodiment, the data portion includes rules indicating how the data should be processed. As described above, such rules may include rules indicating a subset of otherwise eligible users designated to receive the content. In one embodiment, the rules may include computations to be performed prior to delivering the content to individual users. In one embodiment, such computations are performed by retrieving user profile data from the user profile database and performing computations based at least in part on such data.

In step 810 of the process shown in FIG. 8, the transcoder passes the data portion of the content, including any embedded rules, and the associated presentation format to the dispatcher, such as the dispatcher 608 of the regional server 604 shown in FIG. 6.

In step 812 of the process shown in FIG. 8, the dispatcher forwards the data portion of the content, including any embedded rules, and the presentation format to the local servers associated with the regional server. In one embodiment, the dispatcher immediately forwards the content and presentation format information to the local servers upon receipt of such information from the transcoder. In one embodiment, the dispatcher may process some or all of the rules associated with the content prior to delivering the content and associated presentation format information to the local servers. For example, the dispatcher may include a rule engine configured to deliver the content to only a subset of the local servers associated with the regional server, if appropriate, such as where the rules indicate that the content is to be delivered to only a subset of users, the subset of users being associated with only a subset of the local servers associated with the regional server.

The process shown in FIG. 8 ends in step 814.

FIG. 9 is a schematic diagram illustrating a portion of a system used in one embodiment to deliver data services via wireless mobile devices. The system includes a regional server 904 connected to one or more associated local servers, including a local server 914.

The local server 914 includes a local content database 918 configured to receive and store content received from regional server 904. The local server 914 further includes a rule engine 916 configured to receive and process content stored in local content database 918.

The rule engine 916 is further configured to access user profile data from a local user profile database 920. The local user profile database 920 is configured to receive user profile data from the regional server 904 such as by operation of a metadata engine within the regional server 904, such as the metadata engine 609 shown in FIG. 6. In one embodiment, the rule engine 916 is configured to use data from local user profile database 920 to identify a subset of users to whom the content should be delivered. In one embodiment, the rule engine 916 is configured to use user profile data from the local user profile database 920 to personalize content prior to delivery to individual users such as by performing computations based at least in part on user profile data prior to delivering content reflecting such computations to the individual users.

The rule engine 916 is configured to retrieve data from a local service data database 922. The local service data database 922 is configured to receive service data from the regional server 904, such as service data sent to the local server 914 by means of a metadata engine within a regional server 904 such as metadata engine 609 shown in FIG. 6. In one embodiment, the rule engine 916 uses data from the local service data database 922 to process content received from the regional server 914. In one embodiment, the rule engine 916 uses service data from the local service data database 922 to identify the users to whom the content should be delivered, such as by associating a list of subscribed users with the content.

The rule engine 916 is further configured to communicate with a local dispatcher 924, as shown in FIG. 9. In one embodiment the rule engine 916 processes rules embedded in the content received from the regional server 904 to identify the specific users to whom the content should be delivered and, if applicable, the time of delivery for each user. In one embodiment, the time of delivery may be the same for all users. In one embodiment, the time of delivery may be different for different users. In one embodiment, the rule engine 916 creates and sends to the local dispatcher 924 a schedule including an identification of the users to whom the associated content should be sent and the date and time at which the content should be sent to each user. In one alternative embodiment, the rule engine itself manages the schedule and the local dispatcher 924 transmits the content to a user indicated by the rule engine when prompted by the rule engine to do so.

The local dispatcher 924 is configured to deliver content via a wireless network 926 to one or more of a plurality of mobile users 928. In one embodiment, the local dispatcher delivers content to the plurality of mobile users 928 based on a list of users and a schedule of transmission such as described above. In one embodiment, the local dispatcher transmits the content to a user indicated by the rule engine when prompted by the rule engine to do so.

The rule engine 916 is further configured to invoke a local composer 930 in cases where additional content associated with the content received from the regional server must be generated, such as to personalize content for one or more individual users. The local composer 930 is configured to receive content stored in the local content database 918, and to retrieve user profile data from local user profile database 920 and/or service data from local service data database 922, as needed, to generate the additional content required in a particular instance. For example, in one embodiment the local composer 930 is configured to generate personalized content by performing computations based on user profile data. In one embodiment, the local composer 930 may be configured to generate personalized content in which only a subset of the data included in the content received from the content provider is presented. For example, for a stock price quote service the local composer 930 may be used to generate a listing of the quotes for just those stocks included in a particular user's portfolio of stocks of interest.

The additional and/or personalized content generated by the local composer 930 is sent to the rule engine 916 for processing and to be sent to the local dispatcher 924 for delivery to one or more of the plurality of mobile users 928.

In one embodiment, the functionality of the rule engine 916, the local composer 930 and the local dispatcher 924 is provided by operation of a microprocessor in local server 914. In one embodiment, the microprocessor comprises a master microprocessor and one or more slave microprocessors so that the computing tasks to be performed by the rule engine 916, the local composer 930, and the local dispatcher 924 may be shared, as necessary and appropriate, among the master and slave microprocessors.

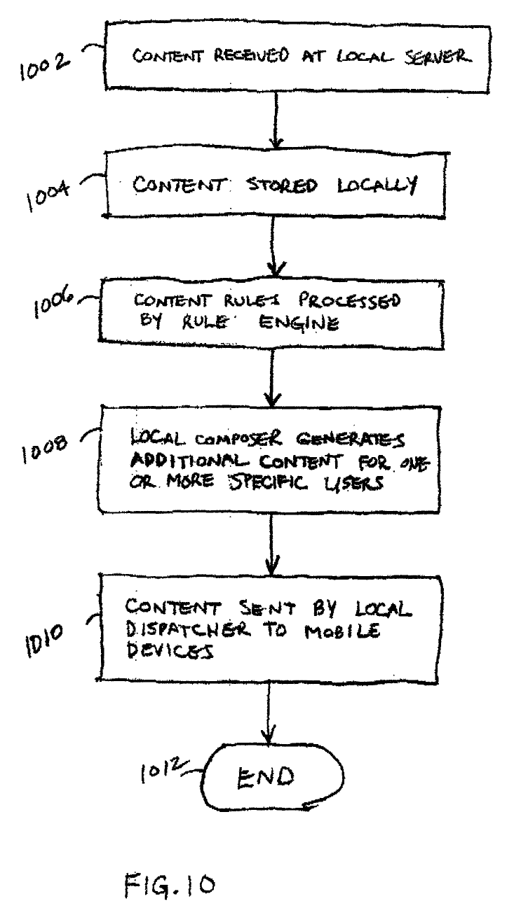

FIG. 10 is a flow chart illustrating a process used in one embodiment to process content at a local server and deliver content to one or more users of wireless mobile devices in a push mode. In step 1002, content is received at the local server. In step 1004, the content is stored locally at the local server. In one embodiment, the content is stored in the form in which it was received from the regional server. In one embodiment, the content is first processed and them stored locally in the processed form. In one embodiment, the processing includes processing rules included in the content, such as the rules for processing the content described above. In one embodiment, the content is first transcoded into a form suitable for delivery to one or more wireless mobile devices, such as into WML, and is then stored locally in transcoded form.

In step 1006, the content rules associated with the content are processed by the rule engine at the local server. In one embodiment, as described above, the processing includes processing rules indicating which user or users should receive the content. In one embodiment, as described above, the processing includes performing computations needed to place the content in a form suitable for being delivered to specific users. In one embodiment, the processing includes associating a presentation format with the content for each user that will receive the content. In one embodiment, as described above, the processing includes assembling a list of recipients to whom the contents should be delivered. In one embodiment, as described above, the processing includes developing a transmission schedule indicating the date and time at which the content should be delivered to each user or group of users, and passing a schedule of such transmission times to a local dispatcher. In one embodiment, the rule engine manages the transmission schedule and at the scheduled delivery times tasks the dispatcher with delivering the content.

In step 1008, a local composer generates additional and/or customized content for transmission to one or more specific wireless mobile devices via a wireless network. Step 1008 is an optional step, which is performed only when it is necessary to generate such additional and/or customized content.

In step 1010, the content is delivered by the local dispatcher to one or more wireless mobile devices. In one embodiment, as described above, content is sent by the local dispatcher to mobile devices under the control and direction of the rule engine. The process shown in FIG. 10 ends in step 1012.

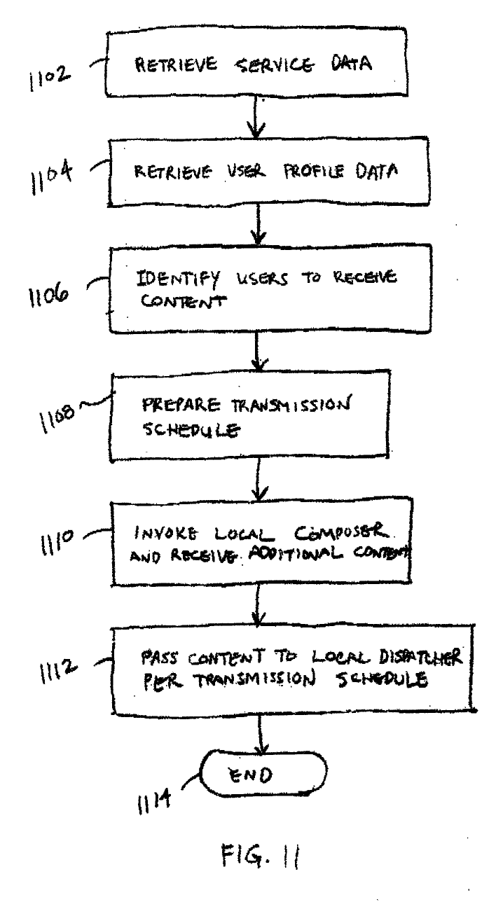

FIG. 11 is a flow chart of a process used in one embodiment by a local server rule engine to process content, as in step 1006 of FIG. 10. In step 1102, the service data associated with the content received from the regional server is retrieved from the local database, such as local service data database 922 of FIG. 9. In step 1104, user profile data is retrieved from a local user profile database such as local user profile database 920 of FIG. 9. In one embodiment, the user profile data retrieved in step 1104 includes user profile data for users associated with the service associated with the content, such as users who are subscribers to the service.

In step 1106, the users to whom the content will be delivered are identified. In one embodiment, the users to whom the content is to be delivered may include all users subscribed to the service associated with the content, in which case step 1106 is omitted.

In step 1108, a transmission schedule is prepared. In one embodiment, the transmission schedule identifies the user or users to whom the content is to be delivered and the date and time at which the content is to be delivered to its user or group of users. In one embodiment, the transmission schedule is based at least in part on content rules contained within the content received from the regional server, which rules specify how the content should be handled and delivered. For example, such content rules may indicate a subset of users to whom the content is to be delivered and/or the timing and manner in which the content is to be delivered. In one embodiment, the transmission schedule is prepared based at least in part on data from the service data database. In one embodiment, the transmission schedule is based at least in part on data retrieved from the user profile database, such as personal data and/or service preferences. In one embodiment, the transmission schedule includes an indication of the presentation format to be used to deliver the content to each user or group of users. In one embodiment, the transmission schedule includes an indication of the form in which the content is to be delivered to each user or group of users as where the local server is configured to communicate with more than one type of wireless mobile device using, for example, either more than one wireless network and/or using more than one wireless communication protocol or format.

In step 1110, the rule engine invokes a local composer, if additional content is to be generated for one or more particular users, and receives additional content generated by the local composer. In one embodiment, as described above, the local composer places the content in a form suitable for delivery to one or more wireless mobile devices via a wireless network, such as by performing computations based on user profile data or selecting and presenting a subset of the content based on user profile data. Step 1110 is optional and is only performed where it is necessary to generate additional content for one or more users.

In step 1112, the rule engine passes the content to a local dispatcher in accordance with the transmission schedule prepared in step 1108. The process ends in step 1114.

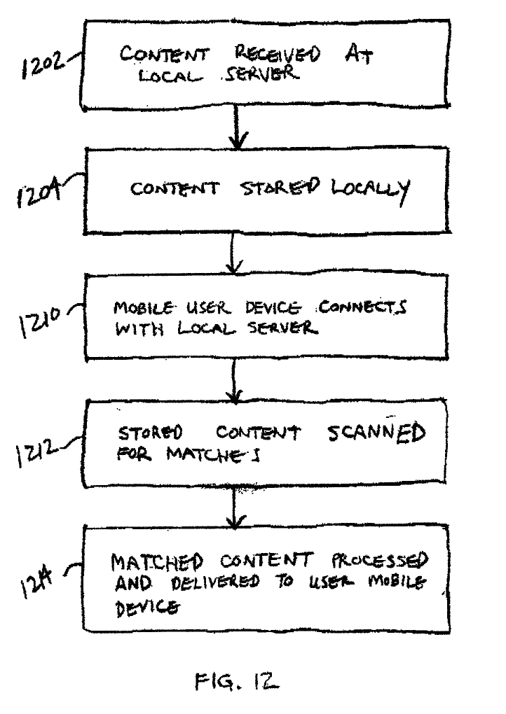

FIG. 12 is a flow chart illustrating a process used in one embodiment to deliver content from a local server to one or more wireless mobile devices via a wireless network in a pull mode. As described above, a pull mode is a mode in which the local server does not deliver content to a wireless mobile device unless or until it receives an indication that the wireless mobile device is ready to receive the content and/or the user of the wireless mobile device desires to receive the content.

In step 1202 of the process shown in FIG. 12, content is received at a local server. In step 1204, the content is stored locally.

In step 1210, a wireless mobile device connects with the local server. In one embodiment, each wireless mobile device to which content may be delivered by the local server is configured to connect with the local server when the wireless mobile device is powered on. In one embodiment, a wireless mobile device connects with the local server in response to an input provided by a user of the wireless mobile device, such as a keypad entry or a voice command. In one embodiment, a wireless device connects with the local server in a predefined or user-defined schedule stored on the mobile device.

In step 1212, the locally stored content is scanned for matches between the content and the user whose wireless mobile device has connected with the local server. In one embodiment, matches are sought by searching for content associated with services associated with the user, such as services to which the user has subscribed. In one embodiment, matches are sought through the rule engine, such as described above in connection with step 1006 of FIG. 10.

In step 1214, the stored content associated with the user whose device has registered with the local server is retrieved and processed, such as by performing any computations necessary to place the content a form suitable for delivery to the user whose device has connected with the local server. For example, computations may be performed based on the user's personal data from the user's user profile to personalize the content prior to delivery to the user. In one embodiment, a local composer may be invoked to generate additional and/or personalized content suitable for transmission to the user. The content is then delivered to the user's wireless mobile device via a wireless network.

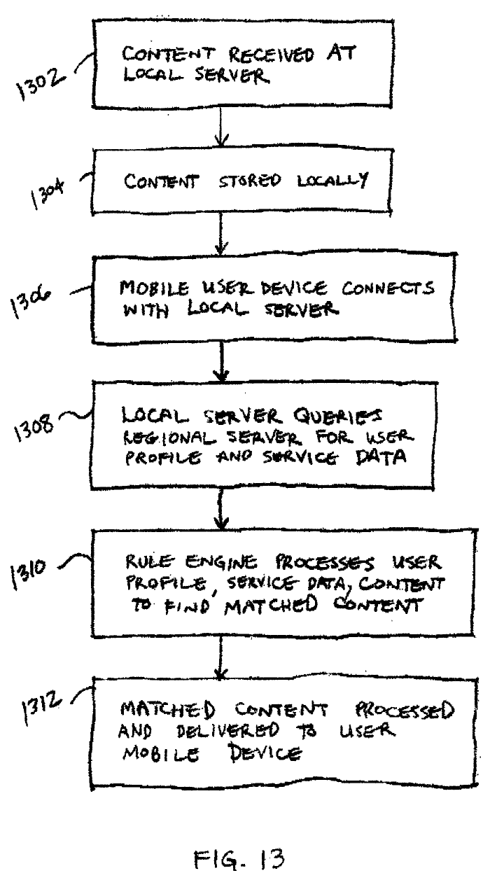

FIG. 13 is a flow chart illustrating a process used in one embodiment to process content at a local server and deliver such content to one or more wireless mobile devices via a wireless network in a pull mode of operation. In step 1302, content is received at the local server. In step 1304, the content is stored locally.

In step 1306 a wireless mobile device connects with the local server. In step 1308, the local server queries a regional server for user profile data and service data. In one embodiment, the user profile data and service data are pushed to the local server by the regional server without the regional server having received a query from the local server. In such an embodiment, the local server in step 1308 merely accesses the previously received user profile data and service data instead of querying the regional server to obtain such data.

In step 1310, a rule engine at the local server processes the user profile data, service data, and the locally stored content to identify content that should be processed for delivery to the wireless mobile device that connected with the local server in step 1306. In one embodiment, the processing performed to identify the content to be delivered to the wireless mobile device that connected with the local server in step 1306 is similar to the processing described above in connection with step 1212 of FIG. 12.

In step 1312, the content identified in step 1310 as being content intended for delivery to the wireless mobile device that connected with the local server in step 1306 is further processed as necessary to deliver to the content to the mobile device. In one embodiment, the further processing is similar to the processing described above in connection with step 1214 of FIG. 12. The content is then delivered to the wireless mobile device via a wireless network.

Although the foregoing invention has been described in some detail for purposes of clarity of understanding, it will be apparent that certain changes and modifications may be practiced within the scope of the appended claims. It should be noted that there are many alternative ways of implementing both the process and apparatus of the present invention. Accordingly, the present embodiments are to be considered as illustrative and not restrictive, and the invention is not to be limited to the details given herein, but may be modified within the scope and equivalents of the appended claims.

What is claimed is:

1. A method for providing a data service via a wireless mobile device, the method comprising the steps of:
receiving at a first node, from a content provider, content associated with the data service, the content comprising a data component;
associating a presentation format with the content;
sending the data component and the associated presentation format to a second node;
associating the content with the wireless mobile device; and
delivering at least the data component of the content from the second node to the wireless mobile device.

2. The method of claim 1, wherein the content is delivered in the presentation format associated with the content.

3. The method of claim 1, wherein the presentation format is associated with the content based on an indication included in the content.

4. The method of claim 3, wherein the indication is associated with a previously-defined presentation format.

5. The method of claim 1, wherein the presentation format is associated with the content based on the identity of the content provider.

6. The method of claim 1, wherein the presentation format is associated with the content based on stored data associated with the data service.

7. The method of claim 1, wherein the presentation format is embedded in the content and the step of associating a presentation format with the content comprises processing the content to extract the presentation format information.

8. The method of claim 1, further comprising associating a second presentation format with the content, the second presentation format being associated with a second wireless mobile device.

9. The method of claim 1, wherein the content is associated with the wireless mobile device based on the identity of a user of the wireless mobile device.

10. The method of claim 1, wherein the content is associated with the wireless mobile device based on stored data.

11. The method of claim 10, wherein the stored data is used to associate the content with a user of the wireless mobile device.

12. The method of claim 11, wherein the stored data indicates the user has subscribed to the data service.

13. The method of claim 1, wherein the content further comprises a rule.

14. The method of claim 13, further comprising processing the rule.

15. The method of claim 14, wherein the processing comprises retrieving stored data.

16. The method of claim 13, wherein the rule specifies a condition that must be satisfied for a user to receive the content.

17. The method of claim 13, wherein a plurality of users is associated with the data service and the rule indicates a subset of the plurality of users to receive the content.

18. The method of claim 13, wherein the rule is interpreted in accordance with a definition file.

19. The method of claim 1, further comprising generating additional content at the second node and associating the additional content with the wireless mobile device.

20. The method of claim 19, wherein the additional content is based at least in part on at least a portion of the data component of the content received from the content provider.

21. The method of claim 19, wherein the additional content is based at least in part on stored data associated with the wireless mobile device.

22. The method of claim 1, further comprising processing the data component prior to delivering the content to the wireless mobile device.

23. The method of claim 22, wherein the processing comprises customizing the data to component for delivery to the wireless mobile device.

24. A system for providing a data service via a wireless mobile device, the system comprising:
a first server; and
a second server connected to the first server;
the first server being configured to:
receive, from a content provider, content associated with the data service, the content comprising a data component;
associate a presentation format with the content; and
send at least the data component of the content and the associated presentation format to the second server; and
the second server being configured to:
receive from the first server at least the data component of the content and the associated presentation format;
associate the content with the wireless mobile device; and
deliver at least the data component of the content to the wireless mobile device via a wireless communication network.

25. A system for providing a data service via a wireless mobile device, the system comprising:
means for receiving at a first node, from a content provider, content associated with the data service, the content comprising a data component;
means for associating a presentation format with the content;
means for sending the data component and the associated presentation format to a second node;
means for associating the content with the wireless mobile device; and
means for delivering at least the data component of the content from the second node to the wireless mobile device.

26. A computer program product for providing a data service via a wireless mobile device, the computer program product being embodied in a computer readable medium and comprising computer instructions for:
receiving at a first node, from a content provider, content associated with the data service, the content comprising a data component;
associating a presentation format with the content;
sending the data component and the associated presentation format to a second node;
associating the content with the wireless mobile device; and
delivering at least the data component of the content from the second node to the wireless mobile device.
